(19) United States
(12) Patent Application Publication
(10) Pub. No.: US 2026/0146369 A1
(43) Pub. Date: May 28, 2026

(54) METHOD FOR MELT SPINNING OF POLYMER SAMPLES, MELT SPINNING DEVICE FOR POLYMER SAMPLES AND USING A MELT SPINNING DEVICE FOR PERFORMING A METHOD FOR MELT SPINNING OF POLYMER SAMPLES

(71) Applicant: Textechno Herbert Stein GmbH & Co. KG, Mönchengladbach (DE)

(72) Inventors: Thomas BÖNNEN, Mönchengladbach (DE); Stefan FLIESCHER, Mönchengladbach (DE); Ulrich MÖRSCHEL, Mönchengladbach (DE)

(21) Appl. No.: 19/393,996

(22) Filed: Nov. 19, 2025

(30) Foreign Application Priority Data
Nov. 26, 2024 (DE) 10 2024 134 789.9

(51) Int. Cl. D01D 5/084; D01D 1/04; D01D 5/098; D01D 10/00

(52) U.S. Cl. CPC D01D 5/084; D01D 1/04; D01D 5/098; D01D 10/00; D10B 2401/041

(57) ABSTRACT

A method for melt spinning of polymer samples, and a melt spinning device for polymer samples, as well as a melt spinning device for performing a method for melt spinning of polymer samples are described.

### CROSS REFERENCE TO RELATED APPLICATIONS

The present application claims priority to German Patent Application No. 10 2024 134 789.9 filed Nov. 26, 2024.

The present invention relates to a method for melt spinning of polymer samples and to a melt spinning device for polymer samples, as well as to using a melt spinning device for performing a method for melt spinning of polymer samples.

Both methods and devices for melt spinning thermoplastic polymers are already sufficiently known from the prior art. The methods and devices known from the prior art serve to spin a thermoplastic raw material by heating and extruding it via a nozzle device and pulling it off from the nozzle device, for example via a godet, as at least one thread, in particular as a monofilament thread or multifilament thread. In the prior art, it is necessary that the thermoplastic polymers to be spun by means of the methods and devices have a sufficient quantity in order to be able to spin them using the methods and devices of the prior art. In many cases, the devices known from the prior art are melt spinning devices to which a sufficient quantity of thermoplastic polymers must be continuously supplied in order to ensure a stable melt spinning process.

A disadvantage of the prior art is that the threads of the melted thermoplastic polymer to be dispensed or extruded via the nozzle device first have to be pulled off in a complex manner, for example manually, and placed on godets or other pulling-off devices. Interrupting the continuous melt spinning process is therefore very complex. Furthermore, the aforementioned methods and devices require the supply of a high quantity of a thermoplastic raw material until a stable melt spinning process has been established. In prior art, it is not yet possible to test small quantities of a newly produced polymer for their spinnability, i.e. their properties in a melt spinning process and the resulting fiber properties.

Based on the aforementioned disadvantages of the prior art, the present invention is based on providing a method for melt spinning polymer samples as well as a device for melt spinning polymer samples, by means of which both the smallest thermoplastic sample quantities and larger sample quantities can each be subjected to a stable melt spinning process and the properties obtained for the at least one spun thread can be examined and validated.

According to a first aspect, the object is achieved by a method for melt spinning a polymer sample, comprising the following method steps:
1a) melting at least a portion of the polymer sample,
1b) extruding and binding a first partial quantity of the melted polymer sample onto a depositing body by means of a nozzle device,
1c) spacing the depositing body from the nozzle device to form at least one thread between the nozzle device and the depositing body, and
1d) extruding a second partial quantity of the melted polymer sample via the nozzle device while simultaneously rotating the depositing body about an axis of rotation for stretching and depositing the at least one thread on the depositing body.

Alternatively, the method according to the invention for melt spinning a polymer sample may comprise the following method steps:
2a) melting at least a portion of the polymer sample,
2b) extruding a first partial quantity of the molten polymer sample by means of a nozzle device, pulling off the first partial quantity of the molten polymer sample by means of an air stream to form at least one thread and sucking the at least one thread onto a depositing body by means of a suction device,
2c) preferably spacing the depositing body from the nozzle device, and
2d) extruding a second partial quantity of the melted polymer sample via the nozzle device while simultaneously rotating the depositing body about an axis of rotation for stretching and depositing the at least one thread on the depositing body.

In the context of the present invention, the term of the at least one thread should be understood to mean that a monofilament thread, or simultaneously several monofilament threads or a multifilament thread, can be extruded and pulled off from the nozzle device according to the invention.

According to the invention, a cylindrical depositing body can preferably be selected, which is rotated in step 1d) or 2d) about a longitudinal cylindrical axis of the cylindrical depositing body. According to the invention, however, depositing bodies deviating from the cylindrical shape can also be used, for example with an ovalized, a polygonal or a partially concave cross-sectional shape.

According to the invention, the nozzle device can be arranged at a short distance from the depositing body in method step 1b), wherein the first partial quantity of the polymer sample is extruded directly onto the depositing body in the molten state. In other words, the first partial quantity of the molten polymer is printed or imprinted directly onto the depositing body via the nozzle device, as is known from the field of FDM 3D printers. According to the invention, this achieves the effect that the first partial quantity of the polymer sample is used to first print the extruded material onto the depositing body and thus create a binding between the sample and the depositing body.

According to the invention, the nozzle device comprises at least one nozzle for dispensing the molten polymer, the nozzle having an extrusion axis along which the molten polymer is extruded or dispensed.

According to the invention, the nozzle device can have only a single singular nozzle opening, via which the liquefied polymer is extruded or dispensed and via which a single monofilament thread is then formed from the molten polymer material in method step 1d) or 2d) and dispensed via the nozzle device. According to the invention, however, the nozzle device can alternatively also comprise a plurality of nozzle openings for simultaneously forming several monofilament threads or for forming a multifilament thread.

According to the invention, however, it is may also be provided to arrange the nozzle device at a distance from the depositing body already in method step 2b), to extrude the first partial quantity via the nozzle device and to bind the first partial quantity extruded via the nozzle device to the depositing body by means of suction. Suction can take place, for example, by providing suction openings within the depositing body, wherein the suction openings are connected to a device for generating a negative pressure to create a suction air flow via the suction openings.

It may be provided that the method according to the invention is carried out on a polymer sample with a defined total sample quantity, the total sample quantity being composed of a first and second partial quantity.

According to the invention, the depositing body can be a depositing body with a circular cylindrical depositing surface, for example; the depositing body can particularly preferably be configured as a hollow body with a circular cylindrical shell surface.

An air flow parallel to the extrusion axis in the nozzle device and in the extrusion direction can be provided for pulling off the at least one thread, in particular the at least one monofilament or multifilament thread, from the nozzle device.

According to the invention, it may preferably be provided to heat or cool the air flow to a defined temperature in order to apply a defined temperature to the monofilament or multifilament thread to be pulled off, for example to prevent it from cooling prematurely or to heat it to a defined desired temperature, which is preferably above the ambient temperature. In method step 1d) or 2d), the at least one thread in the area between the nozzle device can be heated using a heat radiation source.

The depositing body can also be heated to and maintained at a predefined temperature using a heating device. According to the invention, it may be provided that during or after depositing the at least one thread on the depositing body, the depositing body is heated to a temperature above the glass transition temperature, particularly preferably in the range of the melting temperature, in order to consolidate the at least one thread, particularly the at least one monofilament thread or multifilament thread, preferably deposited on the depositing body in the form of a depositing pattern, to form a winding body.

Alternatively, it may of course also be provided to provide a cooling air flow to cool the extruded at least one thread.

According to the invention, it may be provided that in method step 1b) or 2b), during the application of the first partial quantity of the molten polymer sample, the depositing body is rotated about the cylinder axis and/or moved in translation along the axis of rotation.

Preferably, during the process of binding the first partial body of the polymer sample to the depositing body, the depositing body can be rotated half a turn or less than half a turn about the axis of rotation.

Particularly preferably, it may be provided that the depositing body is arranged during method step 1b) or 2b) in such a way that the nozzle device is located in a first subarea along the cylinder axis such that the binding of the polymer sample takes place in the first subarea of the depositing body and that after step 1b) or 2b) the depositing body is displaced in translation along the longitudinal cylinder axis, so that the nozzle device is arranged in a second subarea along the cylinder axis, wherein the at least one thread is deposited in the second area of the depositing body.

Furthermore, it may be provided that in method step 1d) or 2d) the depositing body is rotated about the axis of rotation at a resulting speed of the depositing surface of the depositing body in the range from 100 m/minute to 5000 m/minute.

Preferably, according to the invention, the at least one thread is deposited only in a second subarea of the depositing body after the desired surface speed of the depositing body has been reached, and the depositing body can also be moved in translation relative to the nozzle device only in the second subarea in order to deposit the at least one monofilament thread in a depositing pattern on the depositing body in the second subarea only in the second subarea of the depositing body.

Furthermore, it may be provided that the method additionally comprises the following step prior to method step 1b):
applying an adhesion-improving surface coating to at least one subarea of the depositing body, in particular applying an adhesion-improving tape.

Preferably, the adhesion-improving tape is arranged in a first subarea of the depositing body along the longitudinal axis of the depositing body or the first subarea of the depositing body is coated with an adhesion-improving surface coating.

Furthermore, the method according to the invention can comprise the following further method step prior to method step 1b):
arranging the extrusion axis of the nozzle device at the intersection of the horizontal tangent to the highest point of the depositing body and at a short distance from the highest point of the depositing body.

In method step 1b), the nozzle device is positioned above the depositing body and at a small distance from the surface of the depositing body. Furthermore, it may be provided that the method comprises the following further method step after method step 1b):
arranging the extrusion axis of the nozzle device at the intersection of the vertical tangent to the depositing body and above at a defined distance from the intersection of the vertical tangent to the cylindrical depositing body. In method steps 1c) and 1d), the depositing body is moved relative to the nozzle device such that the nozzle device is located at a defined distance above the depositing body.

The method according to the invention can additionally comprise the following method step after method step 1d):
1e) approaching the nozzle device relative to the depositing body and pressing a third partial quantity of the polymer sample onto the depositing body, preferably in a third subarea of the depositing body.

According to a second aspect, the present invention relates to a melt spinning device for polymer samples comprising:
a heating device for melting at least a partial quantity of a polymer sample;
an extruder device for conveying the polymer sample,
a nozzle device for dispensing the melted polymer in the form of at least one monofilament thread, and
a depositing body for depositing the at least one monofilament thread;
wherein the depositing body has a driving device for rotating the depositing body about an axis of rotation, the drive device being configured to rotate the depositing body at high speeds for orienting the molecular chains of the extruded at least one monofilament thread.

It may be provided that the depositing body has an adhesion-improving surface coating in at least one subarea on the depositing surface, which was produced, for example, by means of laser treatment, etching or glass bead blasting. Alternatively, an adhesion-improving tape can also be applied to a subarea of the depositing body.

In particular, the depositing body can be configured as a hollow roll, with the surface of the roll shell being configured as a depositing surface, wherein particularly preferably a plurality of suction holes are provided in the depositing surface, which are connected to a negative pressure device for suction of the at least one monofilament thread to the depositing surface of the depositing body.

The depositing body can also include a heating device to heat at least the area of the depositing surface of the depositing body.

According to the invention, an inductive heating device can preferably be provided for heating the depositing surface of the depositing body. According to the invention, a heating device in the form of a heat radiation source can also be provided, which heats the area of the depositing surface of the depositing body and/or the area between the depositing body and the nozzle device. Preferably, the heat source can be a light source such as a halogen spotlight. Particularly preferably, the heating device can comprise at least one infrared radiation source.

The driving device of the depositing body can also be configured to move and/or pivot the depositing body in translation relative to the nozzle device.

The driving device can be configured such that it can move the depositing body along the axis of rotation of the depositing body and/or orthogonally to the axis of rotation of the depositing body.

The nozzle device can also comprise an actuating device which is configured to move and/or pivot the nozzle device in translation relative to the depositing body.

The extruder device may further comprise a piston-shaped receiving chamber for the polymer sample and a driven plunger for extruding partial quantities of the polymer sample.

The piston-shaped receiving chamber can be fluid-sealed from the environment, for example to hermetically seal the polymer sample from the environment. Particularly preferably it may be provided to pressurize the receiving space for the polymer sample with a gas, such as an inert gas, or particularly preferably to evacuate the receiving space. The pressurization with inert gas or the evacuation of the receiving chamber is preferably carried out before the polymer sample is melted and extruded.

The extruder device can alternatively be a continuous extrusion device, which is configured for continuous extrusion of a filament thread of the polymer sample, as these extrusion devices are known, for example, from the field of FDM 3D printers.

Furthermore, it may be provided that the cylindrical depositing body has at least one depression around the circumference on the depositing surface, with the at least one depression being parallel to the central axis of the depositing body.

Furthermore, the melting device can comprise a sensor device which is configured to detect the pressure prevailing in the polymer melt of the polymer sample with the aim of determining the viscosity of the sample. In a preferred embodiment, the force exerted on the piston is measured for this purpose. Alternatively or additionally, according to the invention, a pressure sensor can also be provided in the receiving chamber in order to measure the pressure acting on the polymer melt.

A third aspect of the present invention relates to the use of a melt spinning device according to the first aspect for performing a method according to the second aspect of the present invention.

In the following, with reference to the attached figures, exemplary embodiments of a melt spinning device for polymer samples according to the invention as well as exemplary method steps of the method according to the invention are illustrated schematically.

### IN THE FIGURES

FIGS. 1A and 1B show a schematic view of parts of a first exemplary embodiment of a melt spinning device according to the invention while extruding and binding a first partial quantity of the polymer sample on a depositing body according to method step 1b);

FIGS. 2A and 2B show a schematic view of parts of a second exemplary embodiment of a melt spinning device according to the invention while extruding, stretching and depositing a second partial quantity of the polymer sample on a depositing body according to method step 1d) or 2d);

FIG. 3 shows a third exemplary embodiment of a melt spinning device according to the invention in a schematic side view; and

FIG. 4 shows a fourth exemplary embodiment of a melt spinning device according to the invention in a schematic front view.

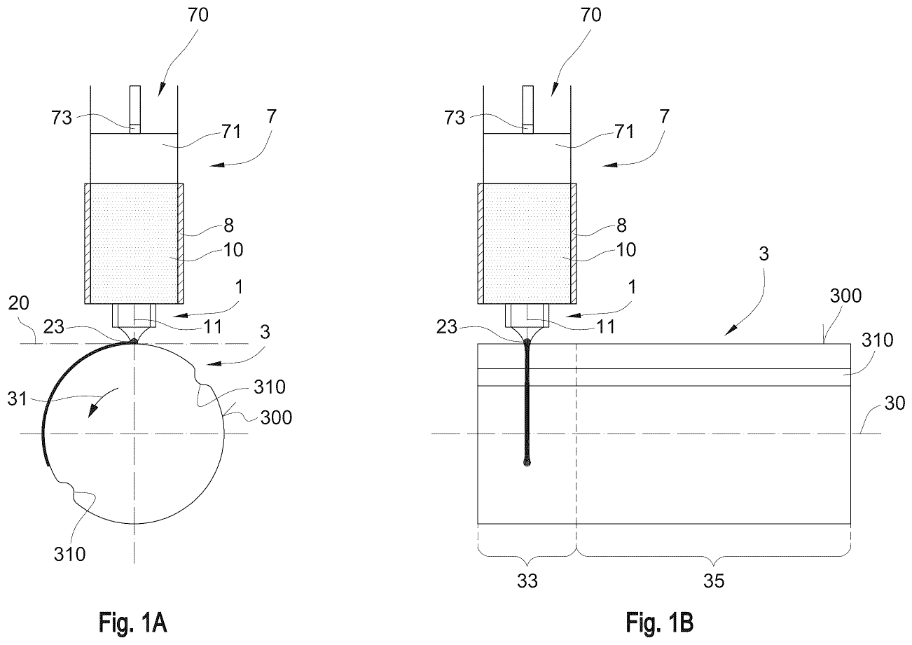

FIGS. 1A and 1B show a simplified and schematic view of parts of a melt spinning device for polymer samples according to the invention, which firstly has a heating device 8 for melting at least a partial quantity of a polymer sample 10, an extruder device 7 for conveying the polymer sample 10, a nozzle device 1 for dispensing the melted polymer 10 in the form of at least one thread and a depositing body 3 for depositing the at least one thread. In the exemplary embodiment shown, the extruder device 7 has a cylindrical receiving chamber 70 for the polymer sample 10 and a driven piston-shaped plunger 71, which is configured to extrude defined quantities of the polymer sample 10. The receiving chamber 70 can be configured to be evacuated or flushed with an inert gas. The heating device 8 shown for melting the partial quantity of polymer sample 10 is configured as a heating sleeve, for example. Furthermore, the extruder device 7 comprises a sensor device 73, which is configured to measure the pressure prevailing in the polymer melt of the polymer sample 10 or the force acting on the extruder device 7.

The depositing body 3 is configured to bind a first partial quantity of the melted polymer sample 10. FIGS. 1A and 1B show the melt spinning device according to the invention during the step of extruding and binding a first partial quantity of the melted polymer sample 10 by means of a nozzle device 1 on the depositing body 3.

FIG. 1A shows the depositing body 3 and the nozzle device 1 in front view of the cylindrical depositing body 3, while FIG. 1B shows a side view of the nozzle device 1 and the depositing body 3 during the same process time. In the embodiment shown, a first partial quantity of a melted polymer sample 10 is extruded onto the depositing body 3 via the nozzle device 1. As symbolized by the curved arrow 31 in FIG. 1A, the depositing body 3 is rotated about the axis of rotation 30 during the application of the first partial quantity of the melted polymer sample 10 on the depositing body 3. Furthermore, it may be provided that the depositing body 3 is also moved in translation along the axis of rotation in the method step shown. As shown in FIGS. 1A and 1B, it can be provided that the binding of the first partial quantity of the melted polymer sample 10 is carried out by means of the nozzle device 1 in a first subsection 33 on the depositing body 3. In the aforementioned first section 33, an adhesion-improving surface coating or surface treatment can preferably be provided. In particular, it can be provided to apply an adhesion-improving tape in the first section 33 and thus enable an improvement in the binding of the first partial quantity to the depositing body 3 or to its depositing surface 300. In the illustrated method step, it may be provided that the extrusion axis 11 of the nozzle device 1 is arranged at the intersection 23 of the horizontal tangent 20 to the highest point of the depositing body 3 and at a small distance from the highest point of the depositing body 3, as shown in FIGS. 1A and 1B.

The illustrated embodiment of the depositing body 3 has two depressions 310 around the circumference on the depositing surface in the illustrated embodiment, which are formed parallel to the central axis of the depositing body 3.

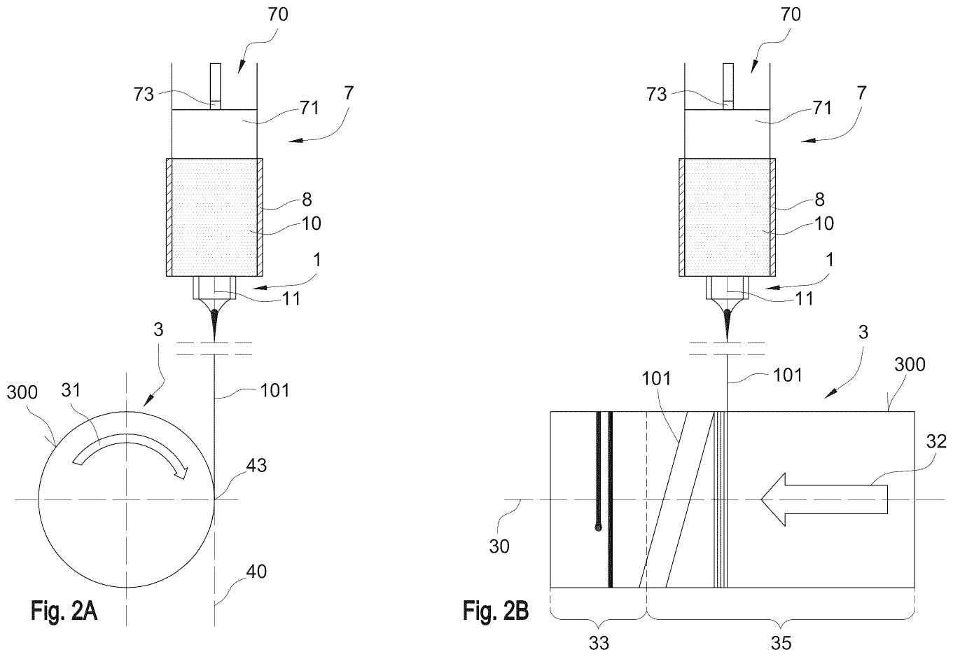

FIGS. 2A and 2B show parts of a second exemplary embodiment of a melt spinning device according to the invention, which differs from the device shown schematically in FIGS. 1A and 1B, in particular in that the depositing body 3 does not have any depressions as seen around the circumference. In FIGS. 2A and 2B, the nozzle device 1 is shown during the extrusion of a second partial quantity of the molten polymer sample 10 via the nozzle device 1 while simultaneously rotating the depositing body 3 about an axis of rotation 30 for stretching and depositing the thread 101 on the depositing body 3.

As shown in FIGS. 2A and 2B, the depositing body preferably comprises a first subarea 33 and a second subarea 35. The extruded thread 101 is preferably deposited in the second depositing area 35. During the extrusion of the second partial quantity, the depositing body 3 is rotated about the axis of rotation 30 at a high speed of the depositing surface 300 of the depositing body 3, which may particularly preferably be in the range from 100 m/min to 5000 m/min. The rotation of the depositing body 3 is shown in FIG. 2A by the curved arrow 31. As can be seen in FIG. 2A, it may be provided that during the step of extruding the second partial quantity of the molten polymer sample 10 via the nozzle device 1 and during the deposition of the at least one thread 101 on the depositing body 3, the depositing body 3 is moved in translation relative to the nozzle device 1 along the axis of rotation 30, as shown by arrow 32 in FIG. 2B. It can be provided that the extrusion axis 11 of the nozzle device 1, as shown in FIG. 2A, is arranged at the intersection 43 of the vertical tangent 40 to the depositing body 3 and above it at a defined distance from the intersection point 43 of the vertical tangent 40 to the depositing body 3.

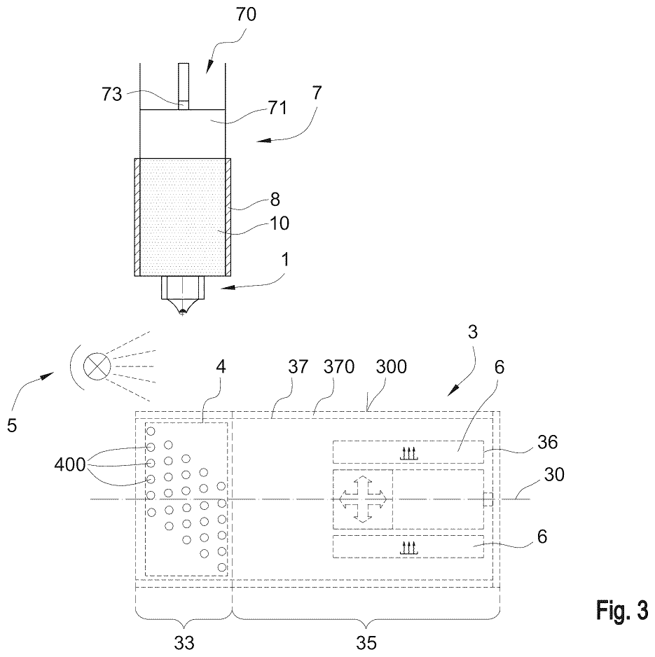

FIG. 3 shows a further exemplary embodiment of a melt spinning device for polymer samples according to the invention. In the illustrated embodiment, the depositing body 3 again has a driving device 36 for rotating the depositing body about an axis of rotation 30, wherein the driving device 36 is configured to rotate the depositing body 3 at high speeds for orienting the molecular chains of the extruded at least one thread. As shown in FIG. 3, the depositing body 3 can be configured as a hollow roll 37, wherein the surface 300 of the roll shell 370 is configured as a depositing surface 300, wherein, by way of example, a plurality of suction holes 400 are provided in the depositing surface 300, which are connected to a negative pressure device 4 and are configured to suck in the at least one thread. As shown in FIG. 3, the suction holes 400 are preferably provided in the first subarea 33 of the depositing body 3, in which area the thread of the extruded polymer sample is to be sucked.

In the illustrated embodiment, the depositing body 3 comprises a heating device 6 for heating the area of the depositing surface 300 of the depositing body 3 to a defined temperature. The driving device 36 of the depositing body 3 can also be configured to move and/or pivot the depositing body 3 in translation relative to the nozzle device 1. The illustrated embodiment further comprises a heat radiation source 5, which is arranged in the area between the nozzle device 1 and the depositing body 3 and is configured to heat or heat up the at least one thread 101.

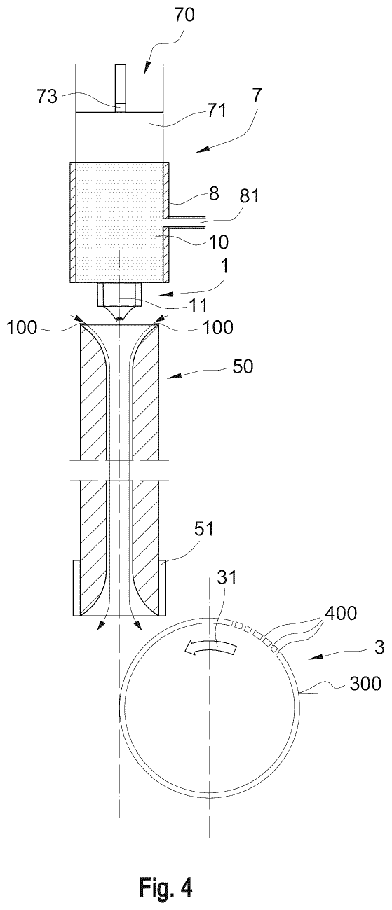

FIG. 4 shows a fourth exemplary embodiment of a melt spinning device for polymer samples according to the invention in a front view. The illustrated embodiment according to FIG. 4 differs from the exemplary embodiments shown above in that a pull-off device 50 for pulling off the at least one thread is arranged between the nozzle device 1 and the depositing body 3. The pull-off device 50 is configured such that the at least one thread ejected by the nozzle device 1 is pulled off the nozzle device 1 by means of an air flow 100 via a corresponding inner channel of the pull-off device 50 and is guided in the direction of the depositing body 3. As shown in FIG. 4, it may be provided that the pull-off device 50 in turn comprises a temperature control device 51, by means of which the at least one thread pulled off and conveyed by the pull-off device 50 can be brought to a defined temperature, in particular cooled. In the illustrated embodiment, the depositing body 3 is configured with a hollow shell, wherein the roll shell 370 is correspondingly configured as a depositing surface 300, wherein the aforementioned depositing surface 300 in turn has a plurality of suction holes 400 in order to suck the at least one thread extruded from the nozzle device 1 and guided via the pull-off device 50 onto the depositing surface 300 of the depositing body 3 by means of negative pressure via the suction holes 400.

The embodiment shown in FIG. 4 is also optionally provided with a channel 81, which is provided and configured to evacuate the receiving chamber 70 of the extruder device 7 or to flush it by means of an inert gas.

What is claimed is:

1. A method for melt spinning polymer samples, comprising the following method steps:
a) melting at least a portion of the polymer sample;
b1) extruding and binding a first partial quantity of the melted polymer sample onto a depositing body by means of a nozzle device and spacing the depositing body from the nozzle device to form at least one thread between the nozzle device and the depositing body or
b2) extruding a first partial quantity of the molten polymer sample by means of a nozzle device, pulling off the first partial quantity of the molten polymer sample by means of an air stream to form at least one thread and sucking the at least one thread onto a depositing body by means of a suction device; and
c) extruding a second partial quantity of the melted polymer sample via the nozzle device while simultaneously rotating the depositing body about an axis of rotation for stretching and depositing the at least one thread on the depositing body.

2. The method for melt spinning polymer samples according to claim 1, further comprising after step b2), spacing the depositing body from the nozzle device.

3. The method according to claim 1, wherein in method step b1) or b2), during the application of the first partial quantity of the molten polymer sample, the depositing body is rotated about the axis of rotation and/or moved in translation along the axis of rotation.

4. The method according to claim 1, wherein in method step c) the depositing body is rotated about the axis of rotation at a resulting speed of the depositing surface of the depositing body in the range from 100 m/minute to 5,000 m/minute.

5. The method according to claim 1, wherein in method step c), during the depositing of the at least one thread on the depositing body, the depositing body is moved in translation relative to the nozzle device along the axis of rotation, for depositing the at least one thread on the depositing body in a depositing pattern.

6. The method according to claim 1, wherein in method step c) the at least one thread is heated in the area between the nozzle device and the depositing body.

7. The method according to claim 6, wherein in method step c) the at least one thread is heated in the area between the nozzle device and the depositing body via a heat radiation source.

8. The method according to claim 1, wherein the depositing body is heated and held at a predefined temperature by means of a heating device.

9. The method according to claim 1, wherein the method additionally comprises the following step prior to method step b1):
applying an adhesion-improving surface coating to at least one subarea of the depositing body.

10. The method according claim 1, wherein the method comprises the following further method step prior to method step b1):
arranging the extrusion axis of the nozzle device at the intersection of the horizontal tangent to the highest point of the depositing body and at a small distance from the highest point of the depositing body.

11. The method according claim 1, wherein the method comprises the following further method step after method step b1):
arranging the extrusion axis of the nozzle device at the intersection of the vertical tangent to the depositing body and above it at a defined distance from the intersection of the vertical tangent to the depositing body.

12. The method according to claim 1, wherein the method additionally comprises the following method step after method step c):
approaching the nozzle device relative to the depositing body and pressing a third partial quantity of the polymer sample onto the depositing body.

13. The method according to claim 12, wherein pressing a third partial quantity of the polymer sample onto the depositing body is performed in a third subarea of the depositing body.

14. A melt spinning device for polymer samples, comprising:
a heating device for melting at least a partial quantity of the polymer sample;
an extruder device for conveying the polymer sample,
a nozzle device for dispensing the molten polymer in the form of at least one thread, and
a depositing body for depositing the at least one thread;
wherein the depositing body has a driving device for rotating the depositing body about an axis of rotation, wherein the driving device is configured to rotate the depositing body at high speeds for orienting the molecular chains of the extruded at least one thread.

15. The melt spinning device according to claim 14, wherein the depositing body is configured as a hollow roll, wherein the surface of the roll shell is configured as a depositing surface.

16. The melt spinning device according to claim 15, wherein a plurality of suction holes are provided in the depositing surface, which are connected to a negative pressure device for sucking the at least one thread.

17. The melt spinning device according to claim 15, wherein the depositing body comprises a heating device for heating the area of the depositing surface of the depositing body.

18. The melt spinning device according to claim 15, wherein the driving device of the depositing body is also configured to move and/or pivot the depositing body in translation relative to the nozzle device.

19. The melt spinning device according to claim 15, wherein the nozzle device comprises an actuating device which is configured to move and/or pivot the nozzle device in translation relative to the depositing body.

20. The melt spinning device according to claim 15, wherein the extruder device comprises a piston-shaped receiving chamber for the polymer sample and a driven plunger for extruding quantities of the polymer sample.

21. The melt spinning device according to claim 15, wherein the receiving space is configured to be evacuated or to be flushed with an inert gas.

22. The melt spinning device according to claim 15, wherein the extruder device is configured as a continuous extrusion device for continuously extruding a filament thread of the polymer sample.

23. The melt spinning device according to claim 15, wherein the cylindrical depositing body comprises at least one depression around the circumference of the depositing surface.

24. The melt spinning device according to claim 15, further comprising:
a sensor device configured to detect the pressure prevailing in the polymer melt of the polymer sample and/or, if present, to measure the force acting on the extruder device.
